(19) United States
(12) Patent Application Publication
(10) Pub. No.: US 2023/0157482 A1
(43) Pub. Date: May 25, 2023

(54) Grill Cleaning Tool

(71) Applicant: David John Andersen, Evanston, IL (US)

(72) Inventor: David John Andersen, Evanston, IL (US)

(21) Appl. No.: 17/300,829

(22) Filed: Nov. 19, 2021

(51) Int. Cl. A47J 37/07; A47L 13/34

(52) U.S. Cl. CPC A47J 37/0786; A47L 13/34

(57) ABSTRACT

A grill cleaning tool is disclosed that picks up remnant wire bristles that may be produced during the cleaning of a grill with wire bristle brush. The grill cleaning tool includes a handle having a proximal end and a distal end and a head connected to the distal end of the handle. The head has a top surface and a bottom surface and is wider than the handle. A magnet is also connected to the bottom surface of the head. A shroud is further provided that is removeably connected to the bottom surface of the head adjacent the magnet. The shroud substantially covers the magnet and is formed from a magnetically permeable material. In use, the handle is gripped by a user and moved across the grill with the bottom surface directed down toward the grill. The magnet is operable to magnetically attract the remnant metal bristles produced during a cleaning of the grill with the wire bristle cleaning tool and secure them against the shroud for later disposal.

### TECHNICAL FIELD

The present invention relates generally to the field of tools useful to clean a grill. More specifically, this invention relates to a tool useful to pick up remnant wire bristles or portions thereof left behind on the grate of a grill after cleaning the grate with a wire bristle brush.

### BACKGROUND

Many people enjoy cooking on barbeque grills particularly during the summer months. But, cooking on barbeque grill comes with certain associated risks such as food safety and the risk of a burn to the cook or nearby children or adults. However, there is another important safety concern for outdoor grills that comes from the use wire bristle brushes that are often used to clean the grate after its use. There are a variety of different grill cleaning tools known to people that cook regularly on a grill. One of the most well-known grill cleaning tools is a brush with metal wire bristles that are used to remove the remaining food materials left on a grill's grate after its use such as grease or other burnt cooking debris. It is known that wire bristles may fall off these brushes when a person is cleaning the grate. These wire bristles or portions thereof can be very hard to see and can be possibly as small as a human hair and located against the background of a dark grill. This problem can be exacerbated when a person over uses their wire bristle brush causing a more rapid deterioration of the brush. The next time the grill is used food may be prepared by a person without realizing that this food is being placed on a grill containing these remnant bristles. The food may then become embedded with one or more of these wire bristles during the cooking process. As a result, such food when consumed can result in a person accidentally ingesting one or more of these dangerous wire bristles.

Foreign object ingestion is a common reason for many people to visit the emergency room of a hospital. More specifically, in many hospitals every year, patients are admitted to emergency rooms after accidentally consuming one or more of these wire bristles from an adulterated food product cooked on the grate of a barbeque grill that was not properly inspected/cleaned. Since the sale of grills and accessories has risen recently, due to the pandemic, it can be expected that these incidents will continue to rise. The severity of the injuries can range from a puncture to the soft tissue of the esophagus causing pain when a person swallows to more serious situations requiring emergency abdominal surgery.

Nylon bristle brushes are a known alternative to a wire bristle brush. However, as the rigidity of a nylon bristle is generally less than that of a wire bristle some users can find their use to clean a grill less preferable. Namely, cooked-on food materials can be difficult to remove with a nylon brush and may thereby require significantly more effort by the person cleaning the barbeque grill to remove this debris and also ending with a less preferred grate surface.

As a result, there is a need for a grill cleaning tool capable of picking up wire bristles or portions thereof that may have broken off during the cleaning process so that a user can continue to use a wire bristle brush to clean their grill and while avoiding the possible accidental ingestion of a wire bristle or portion thereof.

### SUMMARY OF THE INVENTION

The scope of the present invention is defined solely by the appended claims, and is not affected to any degree by the statements within this summary.

By way of introduction, one aspect of the invention is directed to a grill-cleaning tool adapted to pick up remnant metal bristles produced during a cleaning of the grill with a wire bristle brush. The grill cleaning tool includes a handle having a proximal end and a distal end and a head connected to the distal end of the handle. The head has a top surface and a bottom surface and is wider than the handle. A magnet is also that is connected to the bottom surface of the head. A shroud is further provided that is removeably connected to the bottom surface of the head adjacent the magnet. The shroud substantially covers the magnet and is formed from a magnetically permeable material. In use, the handle is gripped by a user and moved across the grill with the bottom surface directed down toward the grill. The magnet is operable to magnetically attract the remnant metal bristles produced during a cleaning of the grill with the wire bristle cleaning tool and secure them against the shroud for later disposal.

According to another aspect of the invention, a grill cleaning tool for use with cleaning a grill of remnant wire bristles or portions thereof is provided. The grill cleaning tool includes a handle having a proximal end and a distal end A head connected to the distal end of the handle and extending outwardly therefrom is further provided. The head has a top surface and a bottom surface and is wider than the handle. The head further includes a cavity in the bottom surface thereof. A magnet is connected to the cavity in the bottom surface of the head. In use, the handle may be gripped by a user and moved across the grill with the bottom surface directed down toward the grill. The magnet is operable to pick up any remnant wire bristles or portions thereof produced during the cleaning process of the grill with the wire bristle brush.

Throughout this description and in the appended claims, it should be understood that the present invention can be used on grills of many different kinds such as outdoor and indoor barbeque grill. As also used herein, the term “shroud” is intended to include a wide range of materials known to those of ordinary skill in the art such various metal materials and/or various fabric materials together materials know to those of ordinary skill in the art.

### BRIEF DESCRIPTION OF THE DRAWINGS

FIG. 1 is a perspective view of the grill cleaning tool of the present invention according to a first embodiment and illustrating the operation of the grill cleaning tool with the shroud partially removed and the remnant wire bristles attached thereto.

FIG. 2 is a perspective view of the first embodiment of FIG. 1 illustrating the operation of the grill cleaning tool with an associated grill.

FIG. 3 is a perspective view of the first embodiment of FIGS. 1-2 illustrating the shroud attached to the head before use of the embodiment as shown in FIG. 2.

FIG. 4 is a side view of the first embodiment of FIGS. 1-3.

FIG. 5 is a top view of the first embodiment of FIGS. 1-4.

FIG. 6 is a bottom view of the first embodiment of FIGS. 1-5.

FIG. 7 is an exploded view of the first embodiment of FIGS. 1-6 illustrating the head, insert, magnet and shroud.

FIG. 8 is an exploded view of second embodiment of the present invention without an insert.

FIG. 9 is a cross-section of the first embodiment taken along the lines 9-9 as shown in FIG. 3.

FIG. 10 is cross-section of a third embodiment of the present invention similar to that of FIG. 9.

FIGS. 11-12 are an illustration of the first embodiment in use to pick up remnant wire bristles.

FIG. 13 is a bottom view of a fourth embodiment of the present invention having curved magnetic collecting surfaces.

FIG. 14 is a side view of the fourth embodiment of FIG. 13.

FIG. 15 is a partial side view of the fourth embodiment of FIGS. 13-14 illustrating the operation of this embodiment.

FIG. 16 is a bottom view of a fifth embodiment of the present invention illustrating cleaning wire bristles and spaced apart magnets interlaced between the wire bristles.

FIG. 17 is a side view of the fifth embodiment of FIG. 16.

FIG. 18 is a bottom view of sixth embodiment of the present invention illustrating a rectangular wire bristle arrangement with a magnet extending around the perimeter thereof.

FIG. 19 is a side view of the sixth embodiment of FIG. 18.

FIG. 20 is a bottom view of a seventh embodiment of the present invention illustrating grill cleaning tool with only a magnet and forward scraper without any wire bristles.

FIG. 21 is a side view of the seventh embodiment of FIG. 20.

FIG. 22 is a perspective view of an eighth embodiment of the present invention illustrating the use of a fabric shroud and its attachment to the head of the grill cleaning tool.

FIG. 23 is cross-section of the eighth embodiment taken along the lines 23-23 of FIG. 22.

FIG. 24 is a side view of the eighth embodiment of FIGS. 22-23.

FIG. 25 is a perspective view of a ninth embodiment of the present invention illustrating the use of metal tines.

FIG. 26 is a cross-section of the ninth embodiment of FIG. 25 taken along the lines 26-26.

FIG. 27 is a side view of a ninth embodiment of FIGS. 25-26.

FIG. 28 is a front view of the ninth embodiment of FIGS. 25-27 illustrating the operation of the ninth embodiment with an associated grill in partial cross-section.

FIG. 29 is a perspective view of the ninth embodiment of FIGS. 25-28 illustrating the operation of the ninth embodiment with an associated grill.

### DETAILED DESCRIPTION OF THE PREFERRED EMBODIMENTS

The foregoing detailed description and accompanying drawings have been provided by way of explanation and illustration, and are not intended to limit the scope of the appended claims. Many variations in the presently preferred embodiments illustrated herein will be apparent to one of ordinary skill in the art, and remain within the scope of the appended claims and their equivalents.

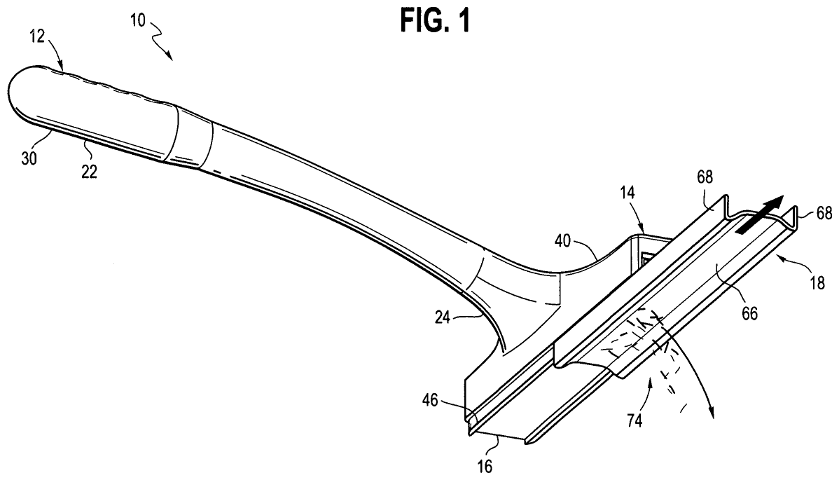

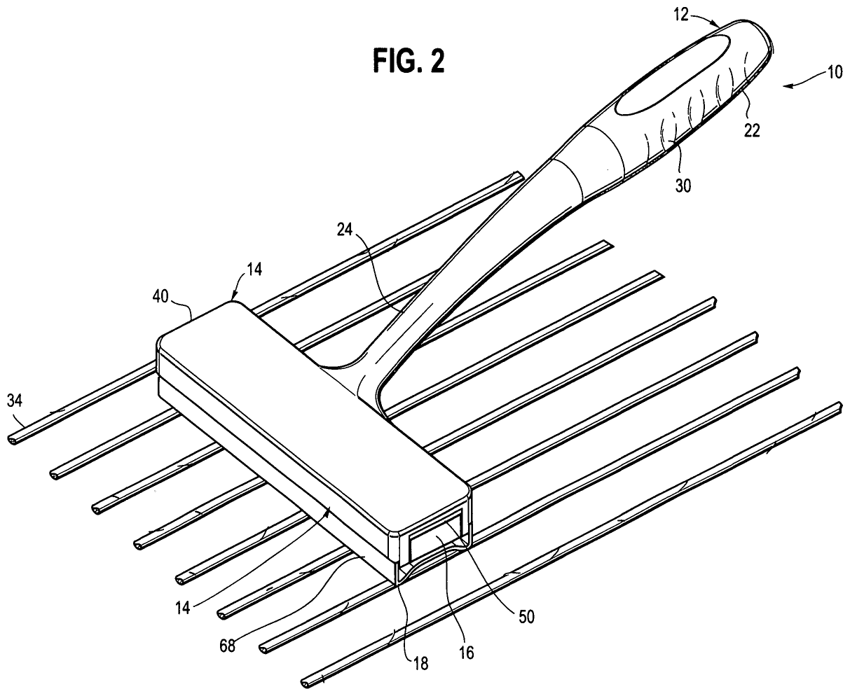

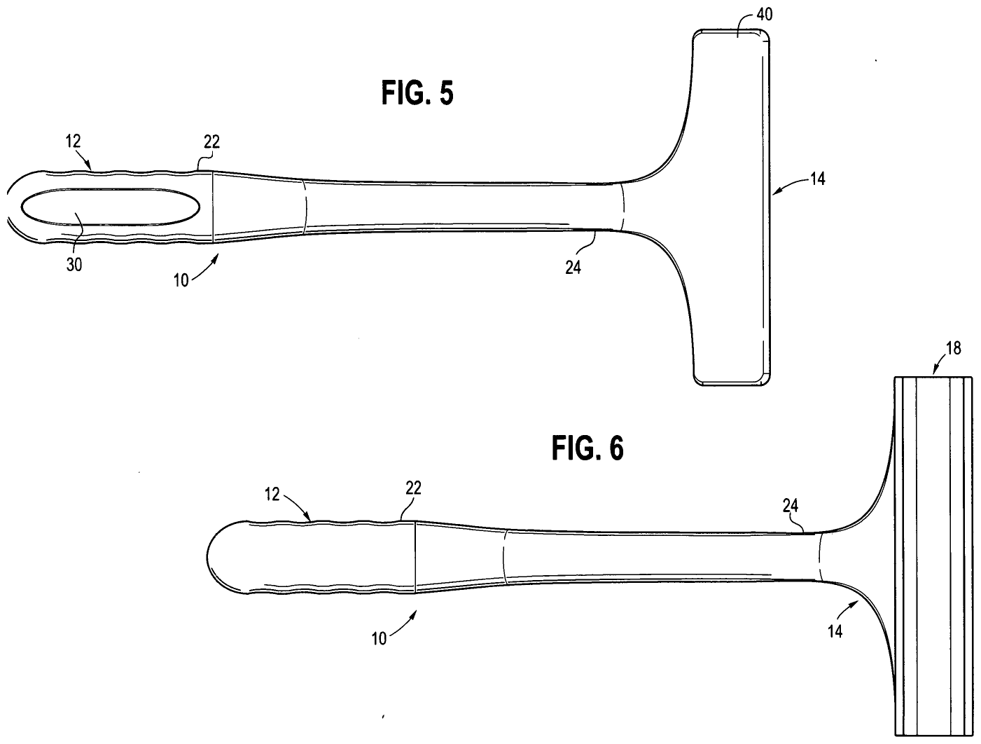

FIG. 1 is a perspective view of a grill cleaning tool 10 according to a first embodiment of the present invention and illustrating its operation. In particular, the grill cleaning tool 10 includes a handle 12, a head 14, a magnet 16 and shroud 18. The handle 12 includes a proximal end 22 and a distal end 24. The distal end 24 is connected to the head 14. The shroud 18 is removably attached the head 14. The handle 12 may be formed any relatively strong material such as wood or a heavyweight plastic. The handle 12 may be formed integrally with the head 14 using the same materials as the handle 12. Alternatively, the head 14 may be formed from a separate material and connected to the handle 12 using known connecting methods. As best seen in FIGS. 2-7, the proximal end 22 of the handle 12 includes a gripping element 30 that may be formed integrally with the handle 12. Alternatively, the gripping element 30 may be formed from a separate deformable material such as a plastic having a different durometer or separate a rubber material. The gripping element 30 is formed so that a user when moving the grill cleaning tool 10 across a grill 34, as shown in FIG. 2, can firmly grip the proximal end 22 of the handle 12.

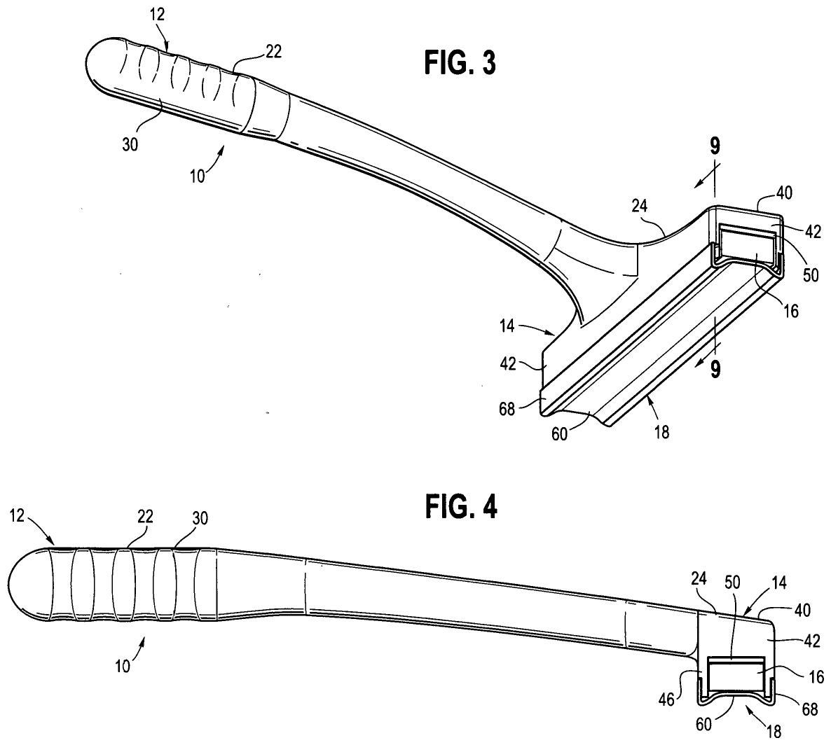

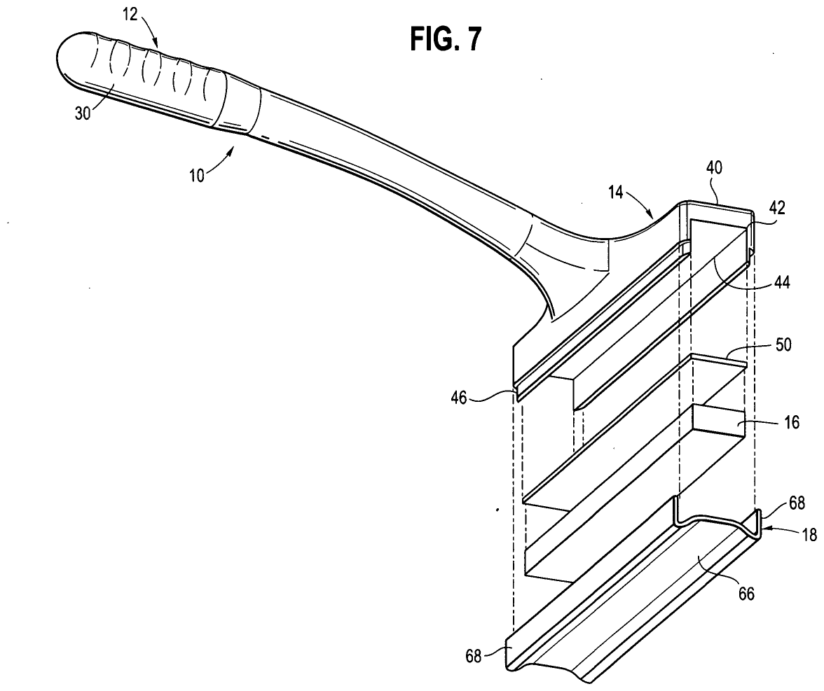

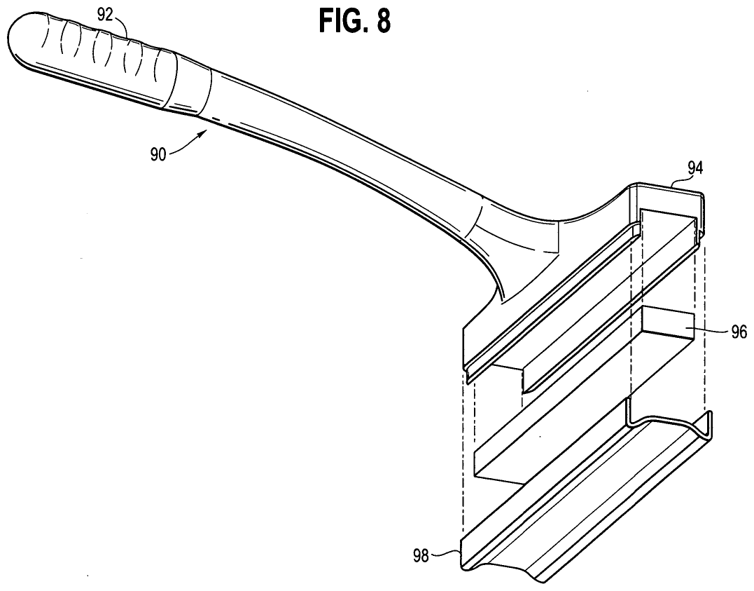

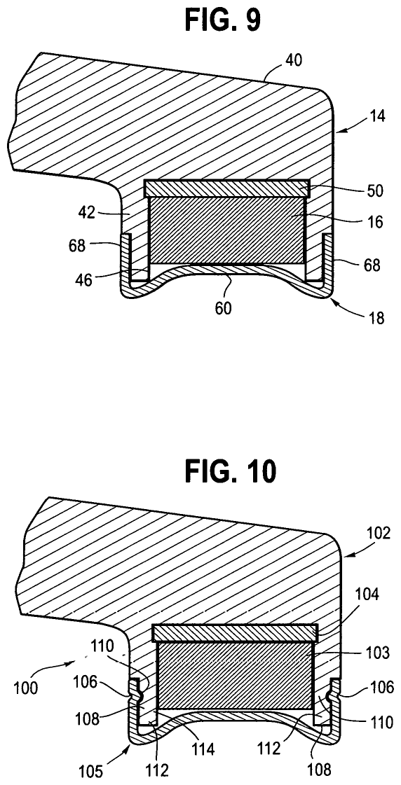

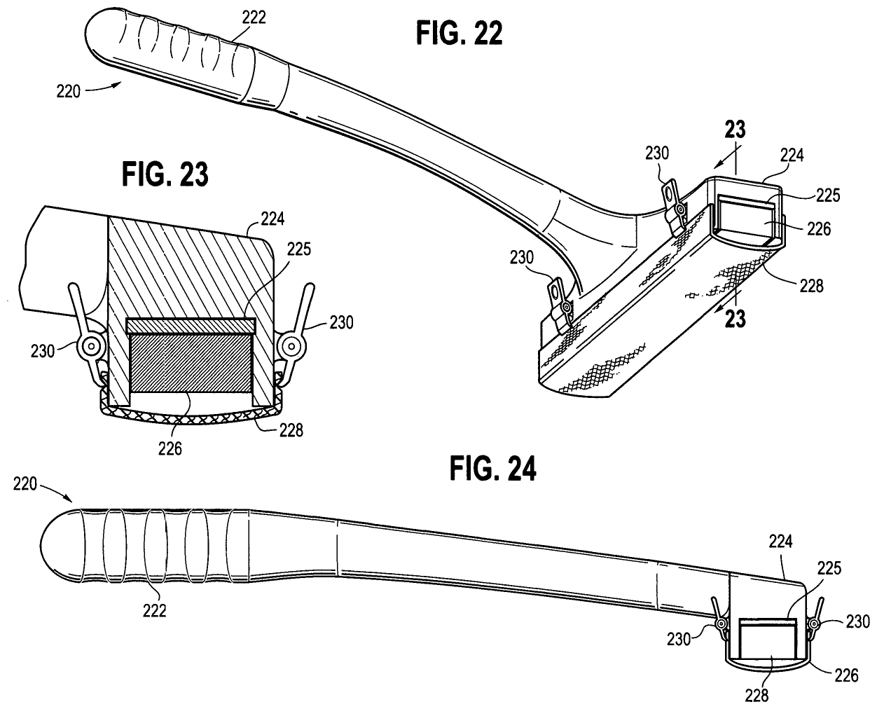

With particular reference to FIGS. 3 and 7, the head 14 includes a top surface 40 and bottom surface 42. More specifically, with reference to the exploded view of FIG. 7, the bottom surface 42 forms a channel 44 and includes two opposing rails 46. An insert 50 is sized to fit within the channel 44. The insert 50 is connected to the channel 44 through the use of an adhesive or other known connecting materials and methods. The magnet 16 is connected to the insert 50 also through use of an adhesive or other known connecting materials and methods. The magnet 16 may be formed from rare earth materials or materials such as samarium cobalt or alnico. As best seen in FIGS. 1 and 7, the shroud 18 is slidably attached to the head 14. The shroud 18 includes a trough 66 and two outwardly extending side walls 68. The side walls 68 slideably engage the rails 46 of the bottom surface 42 of the head 14. The shroud 18 is formed from a magnetically permeable material such as metallic materials including steel, stainless steel, aluminum or other known metallic materials. Alternatively, the shroud 18 could be formed from fabric or cloth material. The shroud 18 is removably connected to the head 14 through interaction with the magnet 16. It should be recognized that the grill cleaning tool 10 of the present may include a shroud formed from other materials such as the embodiment of FIGS. 22-24 that includes a fabric material as further described herein. The cross-section of FIG. 9, illustrates the connection of the insert 50 to the channel 44. This figure also illustrates the connection of the magnet 16 to the insert 50 within the channel 44 of the head 14 with the shroud 18 slidably attached to the opposing rails 46.

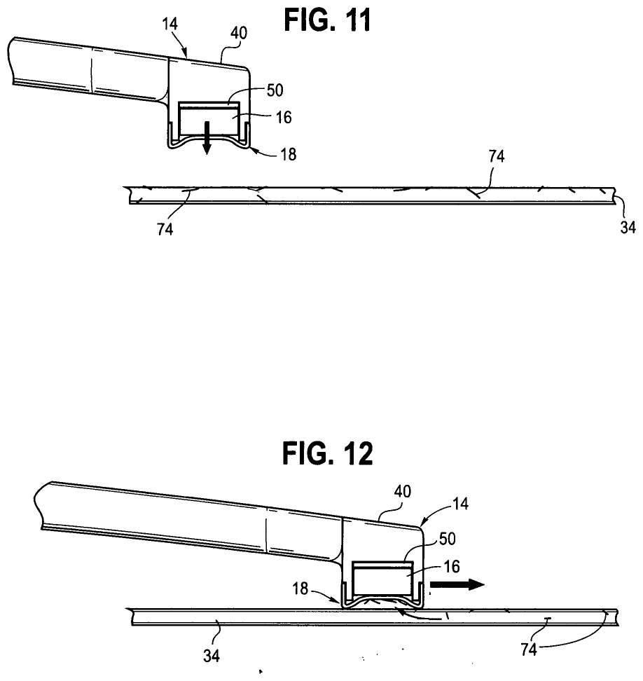

The operation of the grill cleaning tool 10 is best seen in FIGS. 1-2 and 11-12. With reference specifically to FIG. 11, the user brings the grill cleaning tool 10 toward the grate 34 ultimately making contact with the grate 34 as shown in FIGS. 2 and 12. As shown in FIGS. 11 and 12, the grate 34 had been previously cleaned with a wire bristle cleaning brush potentially leaving remnant wire bristles or portions thereof 74 produced during the cleaning of the grate 34. More specifically, the use of a wire bristle brush to clean the grate 34 has been known to leave remnant wire bristles 74 which if not picked up may become embedded in future food materials cooked on the grate 34 and as explained previously in the Background herein. The grill cleaning tool 10 and more specifically, the head 14 is directed downward toward the grate 34 so that the magnet 16 may exert a force through the shroud 18 to pick up the remnant wire bristles 74. It should be recognized the referenced figures show the use of the grill cleaning tool 10 to pick up multiple wire bristles, the present invention is operable to pick up as few as one or more than one wire bristles which may be dangerous if ingested. The grill cleaning tool 10 and more specifically, the head 14 is moved across the grate 34 so as to pick up remnant wire bristles 74. It is suggested that the entire grate 34 be covered with this motion to pick up the remnant wire bristles 74. Once the entire grate 34 is covered with this motion, the grill cleaning tool 10 may be taken to a location where the wire bristles 74 may be safely disposed of into a waste receptacle such as a garbage can. More specifically, as shown in FIG. 1, the shroud 18 may be slid across the rails 46 and thereby disengaged from the magnet 16 and the head 14. Once the shroud 18 is removed from close interaction with the magnet 16, the associated magnetic force is thereby dissipated allowing the remnant wire bristles 74 to be safely disposed of into the waste receptacle.

FIGS. 8 and 10 illustrate two alternate embodiments of the grill cleaning tool of the present invention. With reference to FIG. 8, the grill cleaning tool 90 is related to the embodiment of FIGS. 1-7 and 11-13 with exception that the insert 50 is not included. The grill cleaning tool 90 includes a handle 92, a head 94, a magnet 96, and a shroud 98. With reference to the cross-section of FIG. 10, another embodiment is disclosed. The grill cleaning tool 100 includes a head 102, a magnet 103, an insert 104 and a shroud 105. The shroud 105 has two opposing ridges 106 extending from the side walls 108 that slideably engage notches 110 in the rails 112 of the bottom surface 114 of the head 102.

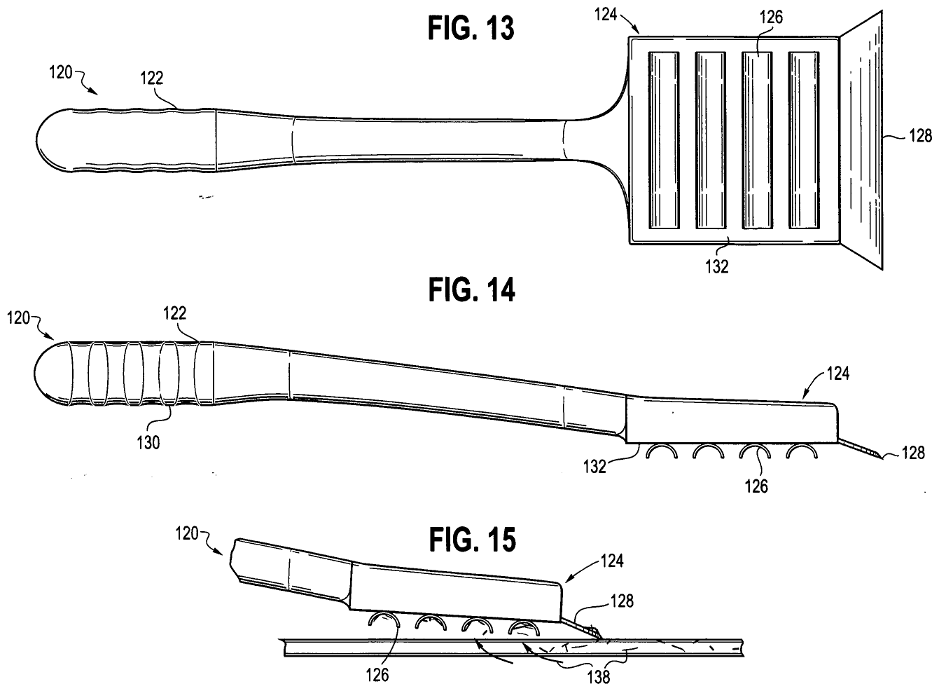

FIGS. 13-15 illustrate a fourth embodiment of the present invention. The grill cleaning tool 120 includes a handle 122, a head 124, curved scrapers 126 and a forward projecting flat scraper 128. The handle 122 includes a gripping element 130 similar to that shown in FIGS. 1-8. The curved scrapers 126 project downward from a bottom surface 132 of the head 124. The curved scrapers 126 can be formed from known metallic materials such as steel, stainless steel, iron and other know materials. The curved scrapers 126 have a generally half-circular shape as shown in FIGS. 13-15. There is magnet located behind the scrapers 126 so to attract the remnant wire bristles in manner similar to the previous embodiments. It should be recognized that fewer than four curved scrapers 126 could be implemented and more than four curved scrapers could be implemented in alternative embodiments of the present invention. Also, the curved scrapers 126 may be formed in different shapes other than the one illustrated and still be within the scope of the present invention. The forward projecting flat scraper 128 can be formed known materials such as steel, aluminum or other materials known to those of ordinary skill in the art. Alternatively, in another embodiment, the forward projecting flat scraper 128 may formed from a material having magnetic properties.

In operation, as shown in FIG. 15, and after the grill 136 has been cleaned with a wire bristle brush, the grill cleaning tool 120 may be moved across the grate 136 with the forward projecting flat scraper 128 picking up any remnant food material remaining after the cooking process and with curved scrapers 126 picking up any remnant wire bristles 138 that may have been deposited during the previous cleaning process with a wire bristle brush. The curved scrapers 126 pick up the remnant wire bristles 138 through interaction with an associated magnet. The curved scrapers 126 may then be wiped off using a paper towel or other disposable material which may optionally be damp to aid in their cleaning with the paper towel then safely disposed of.

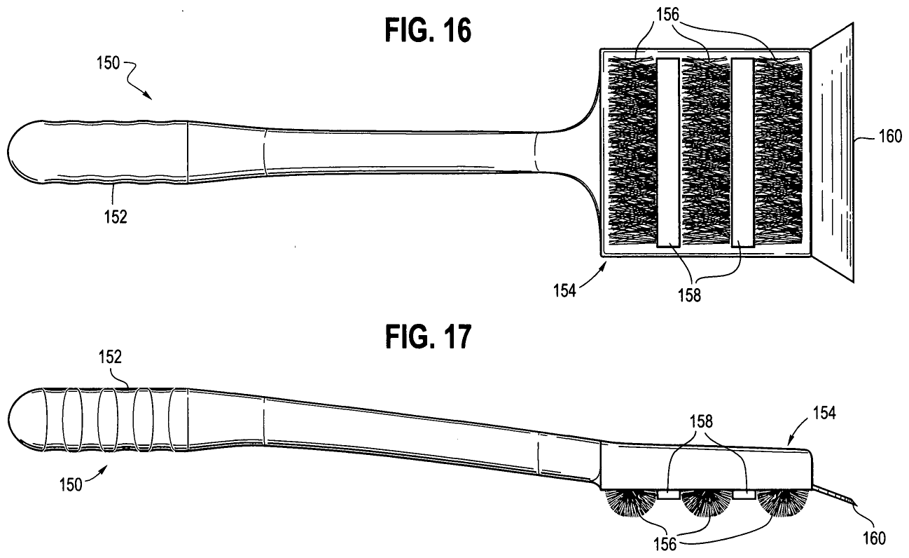

FIGS. 16-17 illustrate a fifth embodiment of the present invention. The grill cleaning tool 150 includes a handle 152 and a head 154 similar to embodiments of FIGS. 1-15. However, the grill cleaning tool 150 includes three wire bristle sections 156 and two spaced apart magnets 158. A forward projecting flat scraper 160 is further provided as in FIGS. 13-15. In operation, the grill tool 150 uses the wire bristle sections 156 in cooperation with the forward projecting flat scraper 160 to pick up any remnant food material remaining after the cooking process with the magnets 158 picking up any remnant wire bristles that may have been deposited during the cleaning process. The magnets 158 pick up the remnant wire bristles and may then be wiped off using a paper towel or other disposable material to clean the magnets 158. It should be recognized that while three wire bristles sections 156 are illustrated fewer than three sections could also be implemented in alternative embodiments. Similarly, the use of less than two magnets may be implemented or more than two magnets may be implemented and still be within the scope of the present invention.

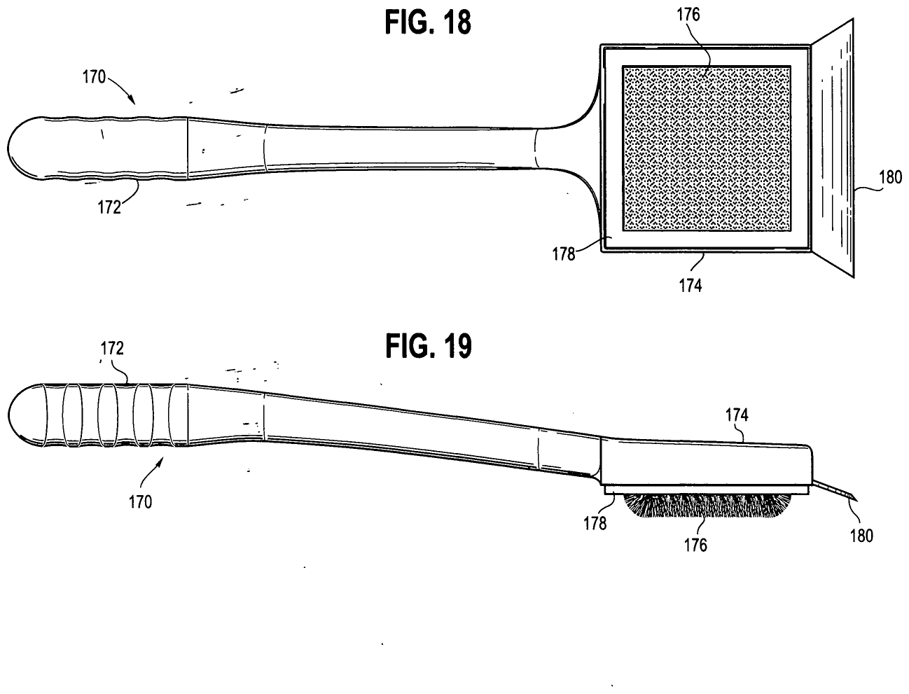

FIGS. 18-19 illustrate a sixth embodiment of the present invention that operates in a somewhat similar way to the embodiment of FIGS. 16-17. The grill cleaning tool 170 includes a handle 172 and a head 174 similar to the previous embodiments. However, the grill cleaning tool 170 includes a rectangular wire bristle section 176 with a magnet 178 located around the perimeter of the wire bristle section 176. A forward projecting flat scraper 180 is again provided. In operation, the grill cleaning tool 170 operates in a similar way as the embodiment of FIGS. 16-17. This embodiment further illustrates that many different embodiments using a one or more wire bristle sections and one or more magnets are within the scope of the present invention. Similarly, the shape and configurations of the elements may also be altered to suit the design purpose of a particular application and again still be within the scope of the present invention.

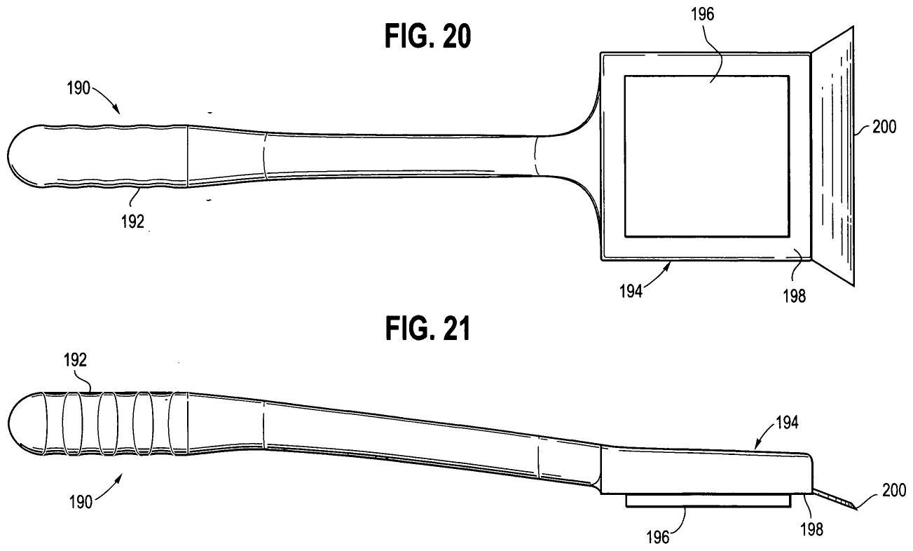

FIGS. 20-21 illustrate a seventh embodiment of the present invention that operates in a somewhat similar way to the embodiment of FIGS. 16-19 with the exception a wire bristle section is not provided. The grill cleaning tool 190 includes a handle 192 and a head 194 similar to the previous embodiments. However, the grill cleaning tool 190 includes a large rectangular magnet 196 located in a bottom surface 198 of the head 194. A forward projecting flat scraper 200 is again provided. In operation, the grill cleaning tool 190 operates in a similar way as the embodiment of FIGS. 16-19 again with exception that it does not include a wire bristle section.

FIGS. 22-24 illustrate an eighth embodiment of the present invention that operates in somewhat similar way to the embodiment of FIGS. 1-12 with the exception that the shroud is not metallic and an alternate connection is provided. More specifically, the grill cleaning tool 220 again includes a handle 222 and a head 224, an insert 225, a magnet 226 and shroud 228. The shroud 228 is removably connected to the head 224 via the clips 230. The shroud 228 is formed from a disposable fabric material such as cotton, cotton blend, wool or natural or synthetic material. The shroud 228 is slightly spaced apart from the magnet 226 so any remnant wire bristles can be pulled more closely toward the magnet 226.

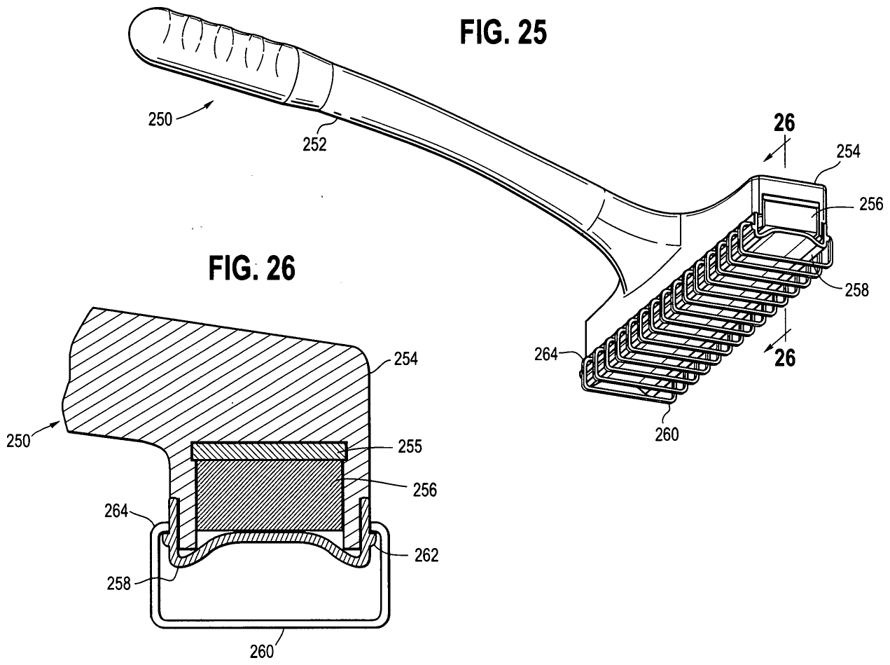

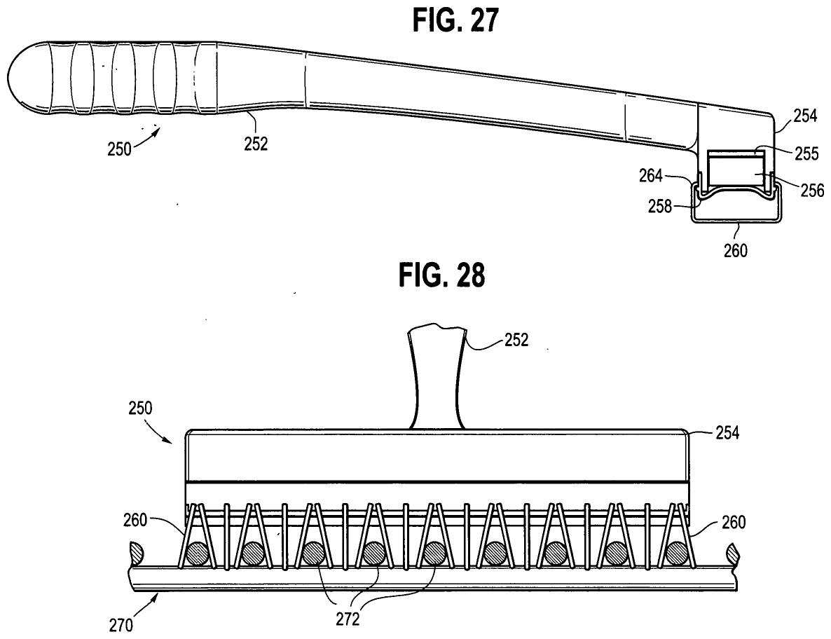

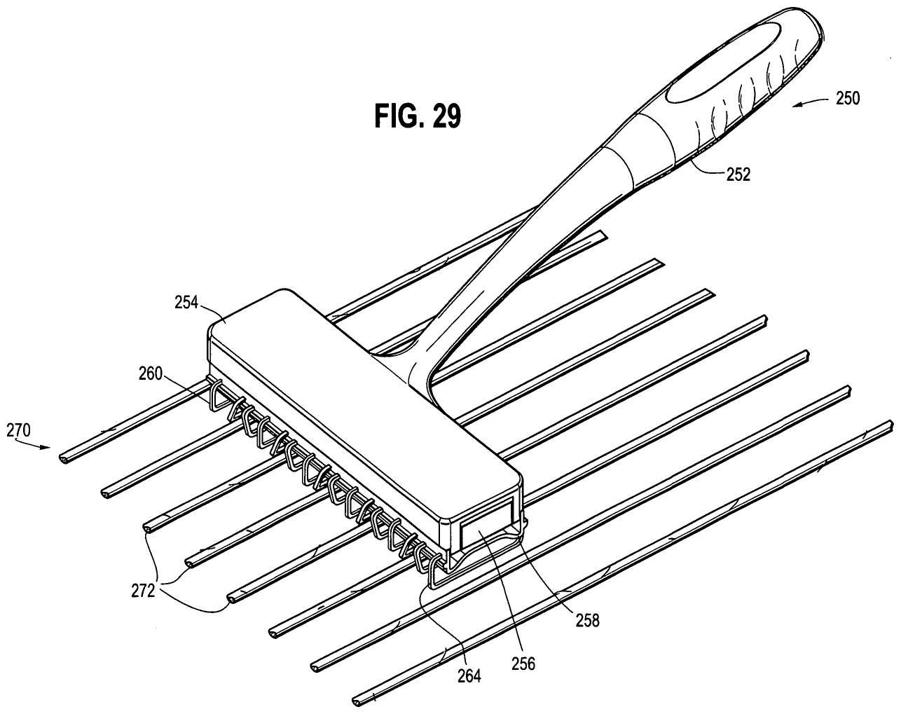

The grill cleaning tool 250 of FIGS. 25-29 operate in a somewhat similar way to the embodiment of FIGS. 1-12 with exception that a series of metal tines are provided to assist in the cleaning process. The grill cleaning tool 250 includes a handle 252, a head 254, an insert 255, a magnet 256 and shroud 258. The present embodiment further includes a series of metal tines 260 attached to the shroud 258. With reference to FIGS. 26-27, the tines 260 have a somewhat rectangular shape with one wall substantially missing at its connection to the shroud 258. More specifically, the shroud 258 incudes a ridge 262 to which the curved ends 264 of the tines 260 can attach. The tines 260 can be fixedly or slideably attached to the shroud. The tines 260 can be formed from a somewhat flexible material such as a metal material including steel, iron, stainless steel or other materials known to those of ordinary skill in the art. In operation, as best shown in FIGS. 28-29, the grill cleaning tool 250 may be pressed onto a grate 270 including the orthongally arrached rods 272. More specifically, the grill cleaning tool 250 may be depressed on the rods 272 such that the tines 260 substantially surround the rods 272. As the grill cleaning tool 250 and in particular the tines 260 are moved across the rods 272, the tines 260 can aid in dislodgement of any remnant wire bristles which will be pulled against the shroud 258 through interaction with the magnet 256. In addition, the tines 260 may be useful to dislodge any remnant food on the grill 270. Once the cleaning process is finished, the shroud 258 may be slideably detached in a manner similar to that illustrated in FIG. 1. After the shroud 258 is detached from the head 254 and separated from the magnet 256, the remnant wire bristles will no longer be magnetically captured and can be properly disposed of.

The embodiments described above and shown herein are illustrative and not restrictive. The scope of the invention is indicated by the claims rather than by the foregoing description and attached drawings. The present invention may be embodied in other specific forms without departing from the spirit of the invention. For example, the material composition of the magnet or size, shape or exact location of the magnet may be designed in a manner other than specifically described or illustrated in the figures or detailed description. Accordingly, these and any other changes which come within the scope of the claims and intended to be embraced herein.

I claim:

1. A grill cleaning tool for use with cleaning a grill grate of remnant wire bristles or portions thereof that have broken off from a wire bristle cleaning tool during a cleaning of the grill, the grill cleaning tool comprising:
a handle having a proximal end and a distal end;
a head connected to the distal end of the handle, the head having a top surface and a bottom surface, the head being wider than the handle;
a magnet connected to the bottom surface of the head;
a shroud removeably connected to the bottom surface of the head adjacent the magnet, the shroud substantially covering the magnet and being magnetically permeable;
whereby the handle may be gripped by a user and moved across the grill with the bottom surface directed down toward the grill and thereby allowing the magnet to magnetically attract remnant metal bristles produced during a cleaning of the grill with the wire bristle cleaning tool and secure them against shroud for later disposal.

2. The grill cleaning tool of claim 1 wherein the shroud is formed from a metal material.

3. The grill cleaning tool of claim 2 wherein the shroud has a trough running laterally across a front surface thereof.

4. The grill cleaning tool of claim 3 wherein the shroud has two opposing side walls extending outward from the trough.

5. The grill cleaning tool of claim 4 wherein the bottom surface of the head includes two opposing rails adapted to slideably engage the two opposing side walls of the shroud.

6. The grill cleaning tool of claim 5 further comprising an insert connected to the bottom surface of the head and the magnet.

7. The grill cleaning tool of claim 6 wherein the magnet is a rare earth bar magnet.

8. The grill cleaning tool of claim 1 wherein the shroud is formed from a fabric material.

9. The grill cleaning tool of claim 8 further comprising two more clips attached to the head to removeably attach the shroud.

10. The grill cleaning tool of claim 9 wherein the magnet is spaced apart from shroud.

11. A grill cleaning tool for use with cleaning a grill of remnant wire bristles or portions thereof produced during cleaning of the grill with a wire bristle brush, the grill cleaning tool comprising:
a handle having a proximal end and a distal end;
a head connected to the distal end of the handle and extending outwardly therefrom, the head having a top surface and a bottom surface, the head being wider than the handle and having a cavity in the bottom surface thereof;
a magnet connected to the cavity in the bottom surface of the head;
whereby the handle may be gripped by a user and moved across the grill with the bottom surface directed down toward the grill and the magnet operable to pick up any remnant wire bristles or portions thereof produced during the cleaning process of the grill with the wire bristle brush.

12. The grill cleaning tool of claim 11 where the cavity is shaped in the form of rectangle.

13. The grill cleaning tool of claim 12 wherein the magnet is shaped in the form of rectangle and side to fit within the cavity.

14. The grill cleaning tool of claim 13 further comprising a shroud connected to bottom surface of the head.

15. The grill cleaning tool of claim 11 further comprising a plurality of outwardly projecting tines connected to the shroud.

16. The grill cleaning tool of claim 15 where the tines are spaced apart.

17. The grill cleaning tool of claim 16 wherein the tines are slideably connected to the shroud.

18. A grill cleaning tool for use with cleaning a grill of remnant wire bristles or portions thereof produced during the cleaning of the grill with a wire bristle cleaning tool, the grill cleaning tool comprising:
a handle having a proximal end and a distal end;
a head connected to the distal end of the handle and extending outwardly therefrom;
a magnet connected to the bottom surface of head;
a plurality of outward extending wire bristles connected to the bottom surface of the head adjacent the magnet;
whereby the handle may be gripped and moved across the grill with the bottom surface directed down toward the grill with the wire bristles operable to clean the grill and the magnet operable to pick up any remnant wire bristles produced during the cleaning process of the grill.

19. The grill cleaning tool of claim 19 wherein the magnet extends substantially around the perimeter of the lower surface of the head.

20. The grill cleaning tool of claim 11 where the magnet includes a portion and a second spaced apart portion with the wire bristles spaced there between.
